(19) United States
(12) Patent Application Publication
(10) Pub. No.: US 2021/0146492 A1
(43) Pub. Date: May 20, 2021

(54) Lighted Guard System

(71) Applicant: Rockford Systems, LLC, Rockford, IL (US)

(72) Inventors: Paul V. Schneider, Belvidere, IL (US); James Shepard, JR., Leaf River, IL (US); Michael J. Thompson, Beloit, WI (US)

(21) Appl. No.: 17/097,160

(22) Filed: Nov. 13, 2020

Related U.S. Application Data
(60) Provisional application No. 62/936,159, filed on Nov. 15, 2019.

(51) Int. Cl. B23Q 11/08; H01H 21/34; F21V 23/04; F21V 33/00; F21S 4/26; G08B 5/36

(52) U.S. Cl. CPC B23Q 11/0891; H01H 21/34; F21V 23/04; F21Y 2115/10; F21S 4/26; G08B 5/36; F21V 33/0076

(57) ABSTRACT

Techniques are disclosed implementing a lighted guard system, which changes from one color (e.g. white) when the guard is down (i.e. closed) and/or a machine associated with the guard is operational, to another color (e.g. red) when the guard is up (i.e. open) and/or the machine associated with the guard is not operational. The triggering of the change in state of the guard may be facilitated by a switch that changes state based upon a position of the guard.

### CROSS-REFERENCE TO RELATED APPLICATIONS

The present application claims priority to provisional application No. 62/936,159, filed on Nov. 15, 2019, the contents of which are incorporated herein by reference in their entirety.

### TECHNICAL FIELD

Aspects described herein generally relate to a lighted guard system and, more particularly, to a lighted guard system with an integrated color-changing light source that changes color based upon the operational state of a machine and/or the position of the guard.

### BACKGROUND

Various types of safety guards, which may be implemented as transparent shields, for instance, are required in manufacturing environments to protect workers or other bystanders from machinery, debris, exposure to chemicals, etc. The guards may be configured to be placed into several different positions. For example, when a machine is off, guards may be placed into an open or unprotective position to allow a worker to load raw materials or otherwise setup the machine to perform a specific task. Once the machine is ready to be used, the guard may then be moved into a closed or protective position. Due to the costs of insurance premiums and safety standards dictated by regulatory agencies (e.g., the Occupational Safety and Health Administration, or OSHA), it is of utmost importance that workers consistently use safety guards in the proper way. Current guard systems, however, may be discreetly bypassed and their improper use (or lack of use) may go unnoticed by a supervisor, especially in a crowded manufacturing floor environment. Therefore, current guard systems are inadequate, as these systems lack measures by which to easily ascertain their proper use, especially at a distance.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1A-1B illustrate an example lighted guard system in a closed or protective position with respect to an operating machine, in accordance with one or more aspects of the present disclosure.

FIG. 1C-1E illustrates an example lighted guard system in an open or unprotective position with respect to an operating machine, in accordance with one or more aspects of the present disclosure.

FIG. 1F illustrates an example lighted guard system showing additional details of the color-changing light source mounting configuration, in accordance with one or more aspects of the present disclosure.

FIG. 2A illustrates an image of an example lighted guard system, in accordance with one or more aspects of the present disclosure.

FIG. 2B illustrates an image of an example lighted guard system in a closed or protective position with respect to an operating machine showing the work area flooded with white light, in accordance with one or more aspects of the present disclosure.

FIG. 2C illustrates an example image of a lighted guard system in an open or unprotective position with respect to an operating machine showing the work area flooded with red light, in accordance with one or more aspects of the present disclosure.

FIG. 3A illustrates an example of mechanical switch actuation used to indicate a position of a guard, in accordance with one or more aspects of the present disclosure.

FIG. 3B illustrates an alternate view of the example switch actuation as shown in FIG. 3A, in accordance with one or more aspects of the present disclosure.

FIG. 3C illustrates an example switch actuation corresponding to the lighted guard system being in the closed or protective position, in accordance with one or more aspects of the present disclosure.

FIG. 3D illustrates an example switch actuation corresponding to the lighted guard system being in the open or unprotective position, in accordance with one or more aspects of the present disclosure.

FIG. 4 illustrates an example circuit diagram for controlling the state of the color-changing light source used by the lighted guard system, in accordance with one or more aspects of the present disclosure.

FIGS. 5A-5B illustrate examples of a color-changing light source, in accordance with one or more aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

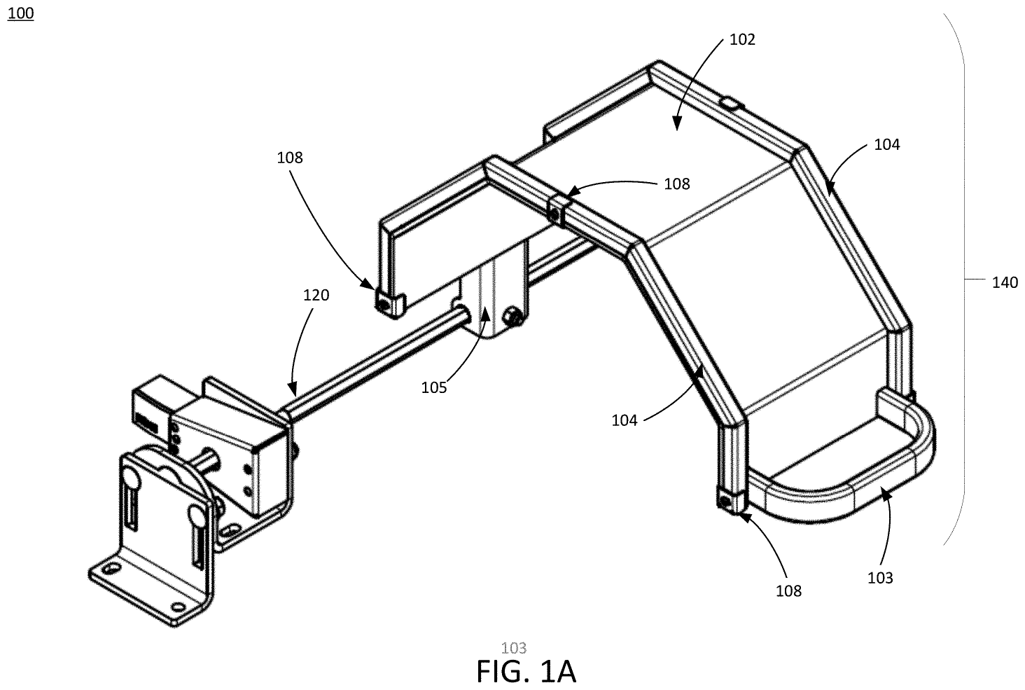

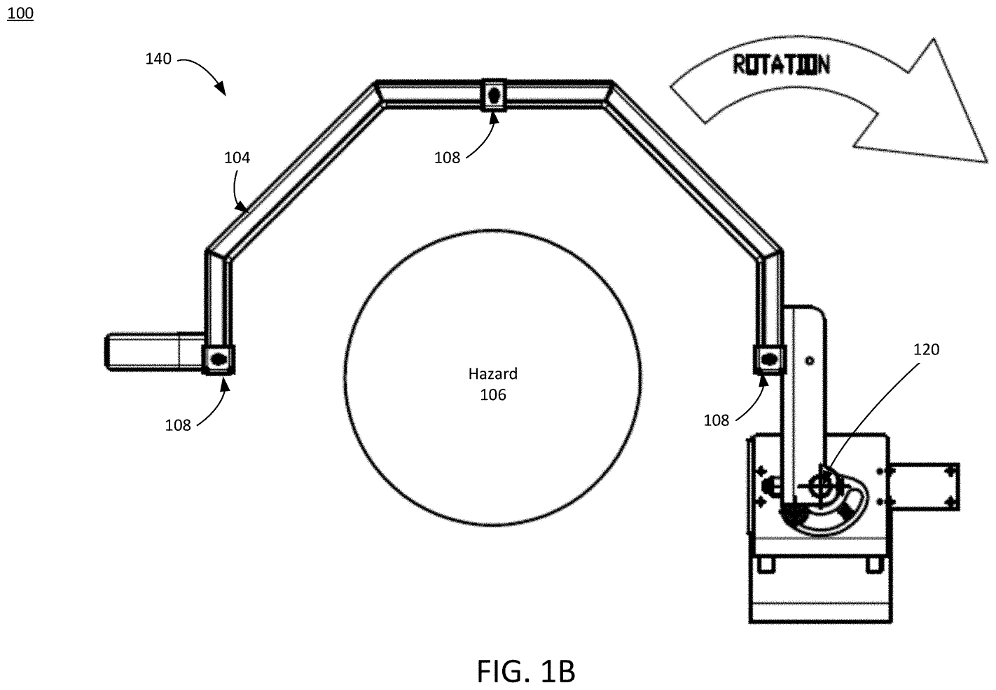

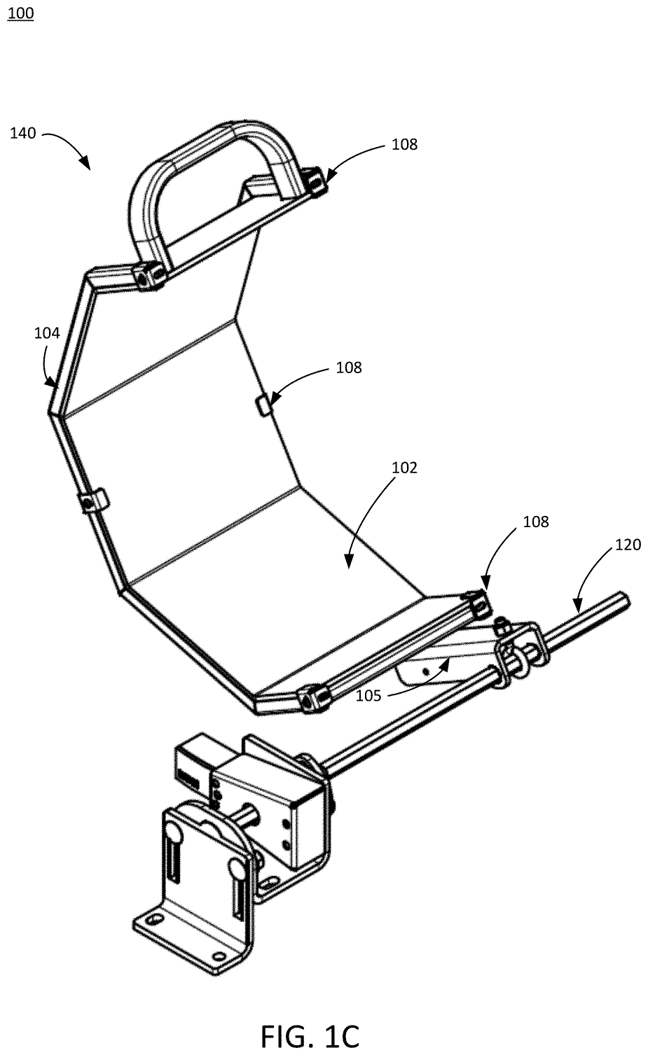

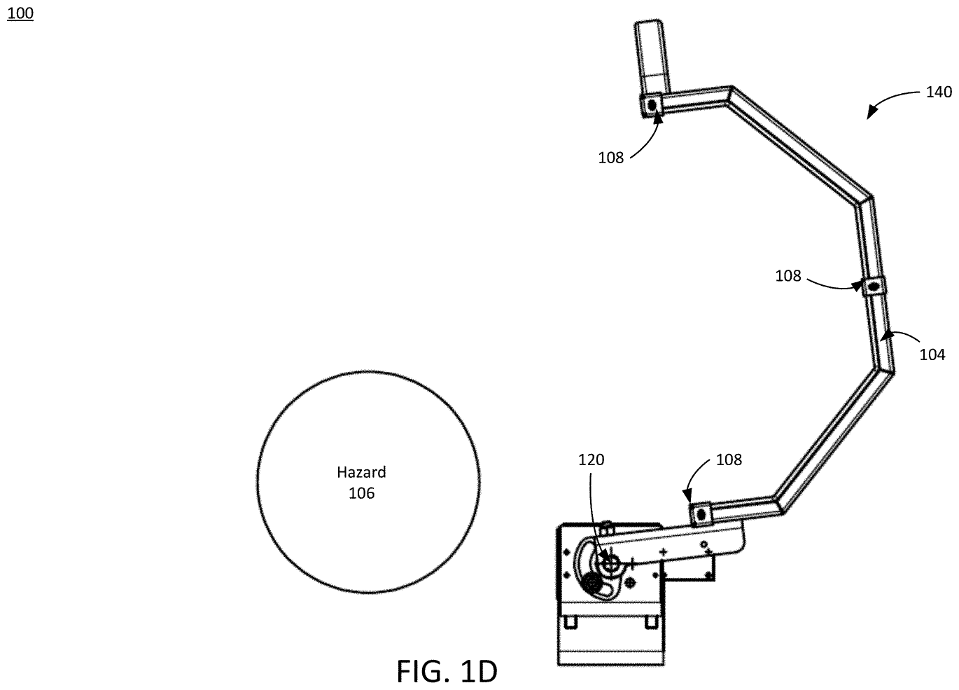

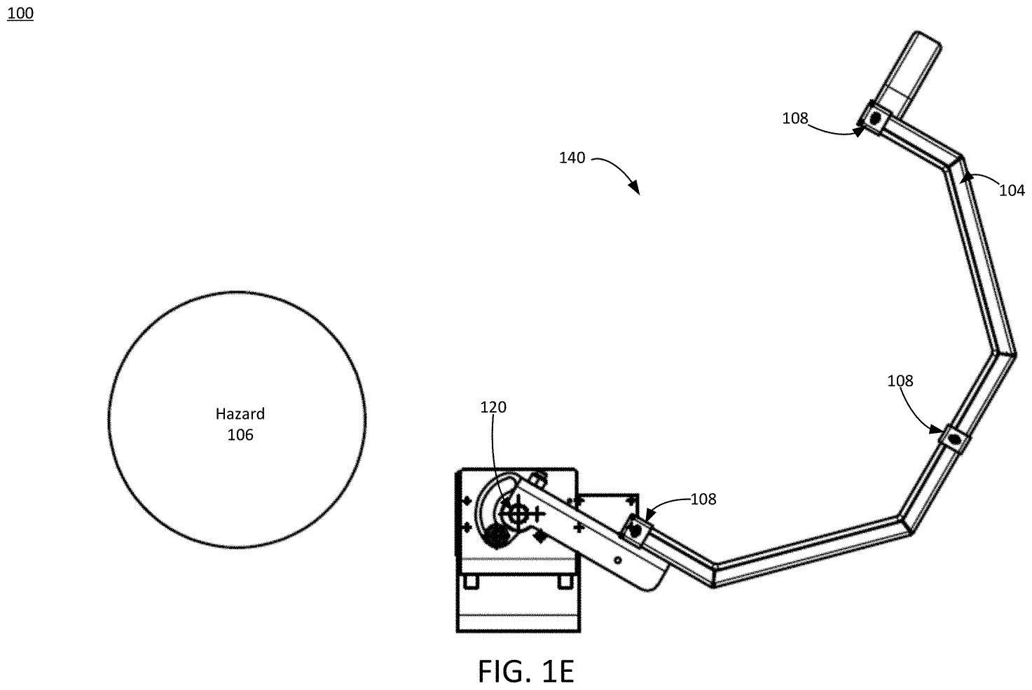

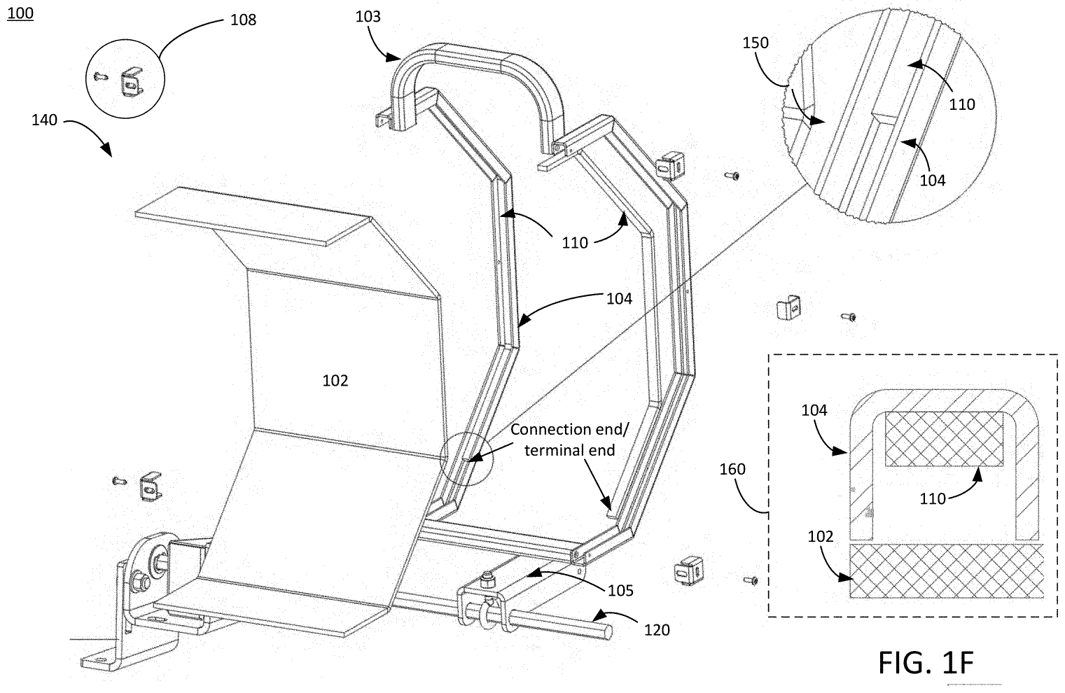

As mentioned above, current safety guard systems lack measures by which to easily ascertain their proper use, especially at a distance. To remedy this issue, the aspects as described herein are directed to a lighted guard system that includes a color-changing light source that is mounted to a safety guard (also referred to herein as a “guard” or “shield”). The color-changing light source may emit a specific color depending upon a position of the guard and/or an operating state of a machine associated with the guard. In particular, and as further discussed below, the aspects described herein implement a lighted guard system having a guard that may be placed in different positions or states. The color-changing light source changes a color of emitted light based upon each of these positions. For example, the guard may be placed in an open or unprotective state in which the guard does not facilitate user protection, as well as a closed or protective state in which protection for the user is provided. FIGS. 1A-1B illustrate different views of an example lighted guard system in the closed or protective position with respect to an operating machine, whereas FIGS. 1C-1E illustrate different views of an example lighted guard system in the open or unprotective state, in accordance with one or more aspects of the present disclosure.

In the examples shown in FIG. 1A-1E, the lighted guard system 100 includes a guard or shield 102 mounted to a frame 104 by fasteners 108. The guard 102, fasteners 108, and frame 104 thus form a lighted guard assembly 140 that is coupled to a rotatable shaft 120 via the mechanical coupling 105. The lighted guard assembly 140 may rotate at least partially about the axis defined by the rotatable shaft 120 to be placed into different positions or operating states. For example, FIG. 1B shows a side view of the lighted guard assembly 140 in the closed or protective state, which also depicts a hazard 106 for which the guard 102 offers protection. FIGS. 1C-1E, in contrast, show the lighted guard assembly 140 in an open or unprotective state with respect to the hazard 106.

In various aspects, the lighted guard assembly 140 may have any suitable range of motion defined in accordance with a particular application or industrial use, and any position within this range of motion may define the state or position of the lighted guard assembly as being protective or unprotective, thereby triggering a change in the color of light and/or state (e.g. off or on) of the color-changing light source, as further described below. For instance, the angular position of the lighted guard assembly 140 as showing in FIG. 1C is less than the angular position of the lighted guard assembly 140 as shown in FIG. 1D. In various aspects, either of these positions (or positions in between) may depict examples of the lighted guard assembly 140 being in the open or unprotected state, which may be based upon mechanical switching actuations detected by the rotation of the rotatable shaft 120 as discussed herein. Furthermore, the aspects described herein are not limited to only two operational states of the lighted guard assembly or two corresponding colors of emitted light. Instead, the aspects described herein may include any suitable number of operational states of the lighted guard assembly 140, which are detected based upon the position of the rotational shaft 120, as further described below. Moreover, the aspects described herein are not limited to the examples shown herein in which the position of the lighted guard assembly 140 is detected via translation into a rotational change of the rotatable shaft 120, and may include any suitable type of detection, actuation, and/or switching mechanisms. As an illustrative example, the position of the lighted guard assembly 140 as shown in FIGS. 1A-1B may correspond to the closed or protective state in which a color-changing light source emits a first light color. Continuing this example, the position of the lighted guard assembly 140 as shown in FIG. 1D and/or FIG. 1E may correspond to an open or unprotective state in which the color-changing light source emits a second light color. The position of the lighted guard assembly as shown in FIG. 1E may correspond to the closed or protective state or another closed or unprotective state in which the color-changing light source emits the second color or a third color of light, in various aspects.

Moreover, the lighted guard system 100 as depicted in the example Figures shown and described throughout the present disclosure is by way of example and not limitation to implement the functionality described herein. For instance, the guard 102 may be any suitable size and/or shape depending upon the particular machine with which the guard is intended to be used (not shown), the size and/or shape of the hazard 106, etc. Moreover, the guard 102 may be manufactured of any type of material suitable for its intended purpose to ensure protection from the hazard 106. The guard 102 may be used, for instance, with any suitable type of machinery, such as those that include rotating parts and/or eject materials during operation (e.g. drills, saws, lathes, etc.), thus protecting an operator or other bystanders from potential injury from the hazard 106.

Turning now to FIG. 1F, an example of the lighted guard system as shown in FIGS. 1A-1E is provided with additional detail regarding the assembly and mounting of a color-changing light source 110. As shown in FIG. 1F, the lighted guard system 100 may further include the color-changing light source 110, which may be attached to the frame 104 of the lighted guard assembly and/or via any suitable means. For example, and as shown in the insets 150, 160 of FIG. 1F, the color-changing light source 110 may be attached to the inner edge of the frame 104 via an adhesive. As additional examples, the color-changing light source 110 may be attached to the frame 104 and/or other portions of the guard 102 via other means such as mounting hardware, double-sided adhesive tape, etc. FIG. 1F also illustrates additional detail with respect to the fasteners 108, which in this example include a clip and accompanying fastener such as a screw, rivet, etc., to captivate the guard 102 within the frame 104 to form the lighted guard assembly 140 that includes the color-changing light source 110. The fasteners 108 shown in the Figures are by way of example and not limitation, and the lighted guard assembly may include any suitable number and/or type of fasteners 108, which may include any suitable type of accompanying hardware or other suitable fastening techniques such as adhesives, cable ties, etc.

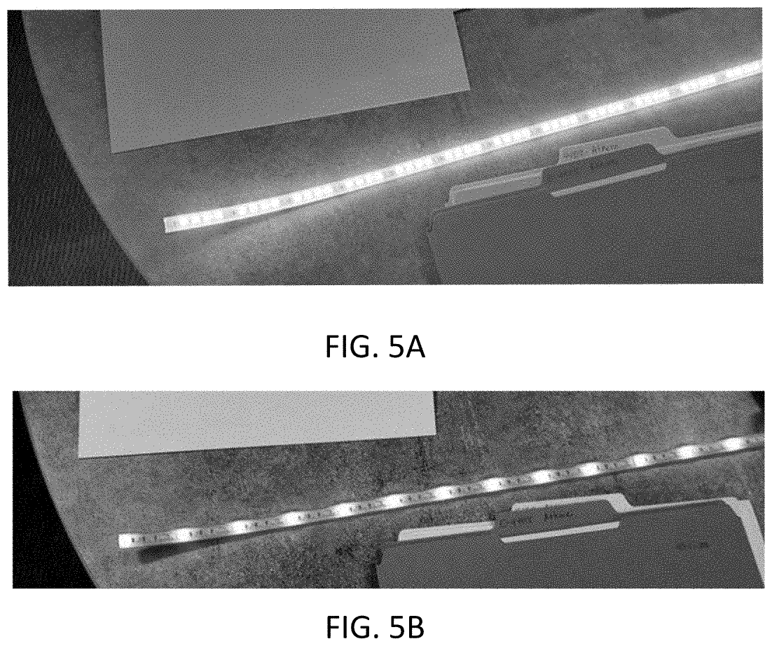

As shown in FIG. 1F, the color-changing light source 110 is implemented as a light strip that may have any suitable shape (e.g. flat) and be routed on the inside of the frame 104 as shown. Examples of the LED light strips implemented as the color-changing light source 110 prior to installation as part of the lighted guard assembly are shown in FIG. 5A (emitting white light in this example) and FIG. 5B (emitting red light in this example). The color-changing light source 110 may comprise a single lighting component or strip and, as one example, be routed through the inside of the frame 104 by passing through the hollow handle 103, although the color-changing light source 110 may be routed or coupled to the frame 104 or other portions of the lighted guard assembly 140 in any suitable manner. Alternatively, the color-changing light source 110 may be comprised of several individual color-changing light sources coupled to one another in any suitable type of configuration to ensure adequate light is emitted from the lighted guard assembly 140. In any event, the color-changing light source 110 may have a terminal end and a connection end, each being located anywhere with respect to the lighted guard assembly 140 depending upon the particular application and desired lighting properties. The terminal end may represent, for instance, a distal end of the lighting strip or other type of color-changing light source that is used, whereas a connection end may include one or more wires, connectors, terminals, etc., configured to selectively provide power to the various different colored light sources (e.g. LEDs) includes as part of the color-changing light source 110 to facilitate the emission of different colored light for different operating states of the lighted guard assembly 140.

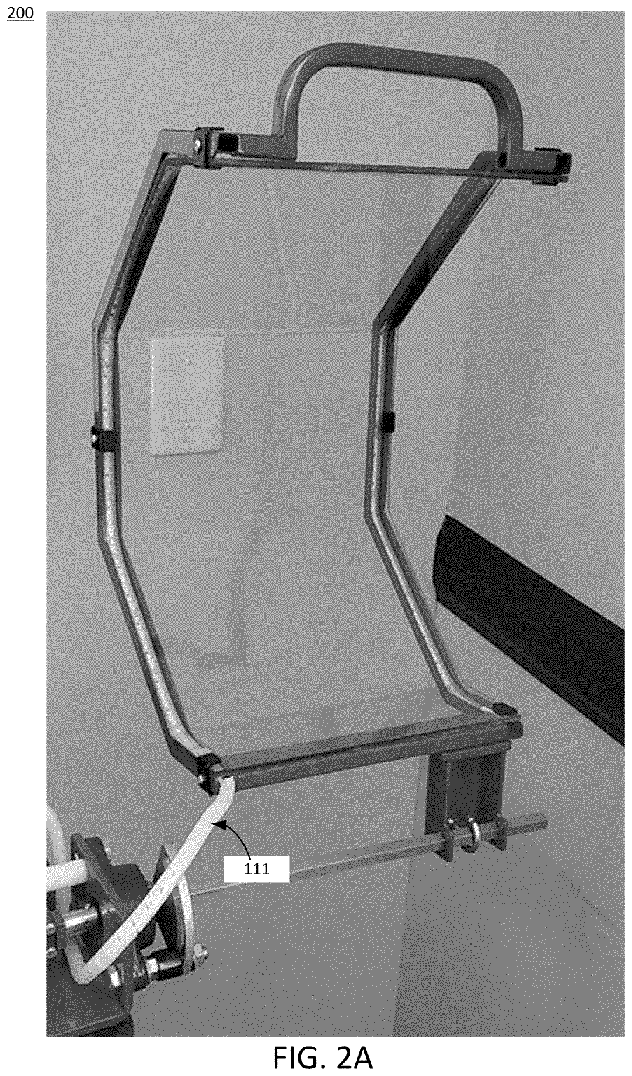

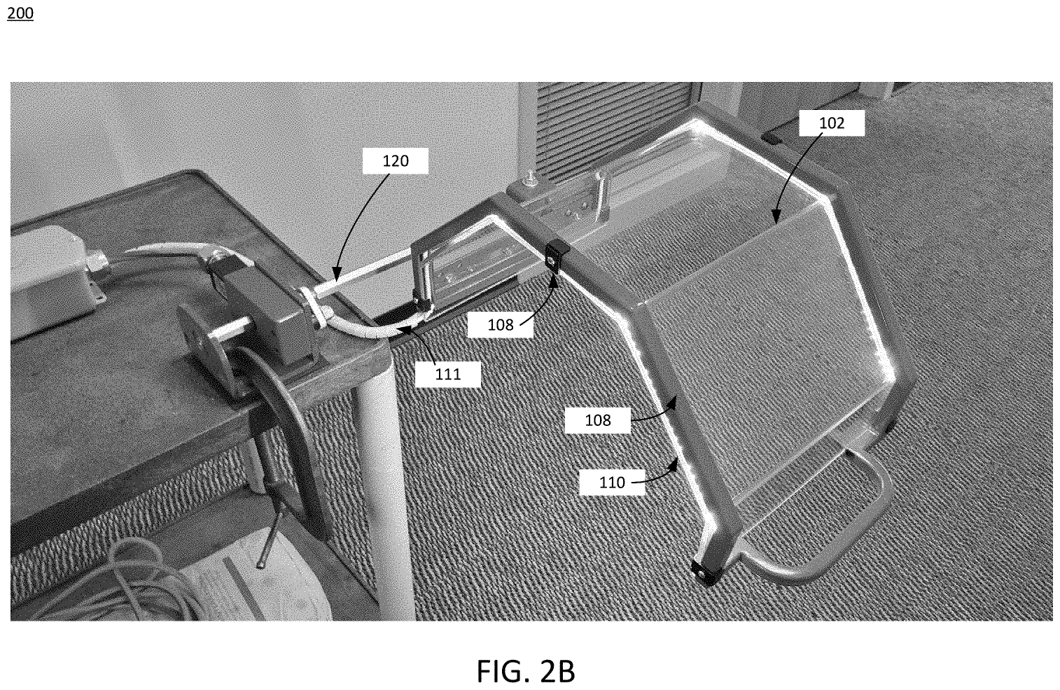

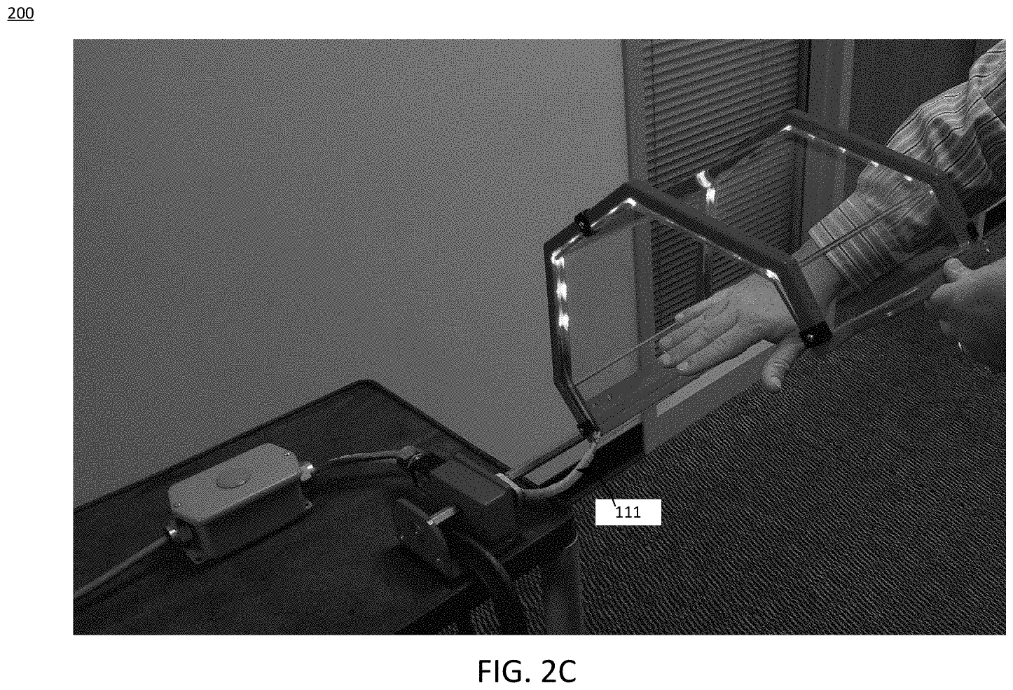

The connection end of the color-changing light source 110 may be coupled to an electrical cable in any suitable manner to receive the appropriate electrical voltages, control signals, etc. to cause the lights included therein to illuminate. These electrical connections are not shown in the Figures for purposes of brevity, but may include any suitable and/or known type of electrical connections such as pig tails, crimped connections, etc. An example of an electrical cable 111, which may be implemented for coupling the electrical voltages to the appropriate terminals associated with the color-changing light source 110 for this purpose, is shown in FIGS. 2A-2C.

The color-changing light source 110 may be implemented as any suitable type of component configured to emit at least two different types of colored light, which may be provided in a direction of the hazard 106 as shown in FIGS. 1B and 1D (e.g. onto the work area) for example, and along any portion (or the entirety of) the lighted guard assembly 140. The color-changing light source 110 may implement any suitable number of lighting components, which may be of any suitable type such as LEDs for example. The aspects described herein may include the color-changing light source 110 being implemented with any suitable type of color-changing light technology in addition to or in combination with LEDs. For instance, the color-changing light source 110 may be implemented as color-changing incandescent lights, color-changing electroluminescent (EL) wire, etc.

Thus, regardless of it implementation, aspects include the color-changing light source 110 dynamically changing the color of emitted light based upon received electrical signals, which may be selectively-provided voltages for example. Again, in the example discussed herein and shown in greater detail in FIGS. 2A-2C, the color-changing light source 110 may be implemented as a strip or array of light-emitting diodes (LEDs). In various aspects, the color-changing light source 110 may implement any suitable number of different colored LEDs, which may be arranged in any suitable number of different ways. For instance, as shown in FIGS. 2A-2C, the color-changing light source 110 is implemented as a strip of LEDs, which includes sets of alternating white (as shown in FIG. 5A) and red (as shown in FIG. 5B) LEDs. Again, the use of two colors, as well as the use of red and white as these two colors, is by way of example and not limitation. The aspects described herein include the color-changing light source 110 being configured to emit any suitable number of different colored light in response to various predetermined conditions being met, as further discussed herein.

Again, these conditions include the state or position of the lighted guard assembly 140, which causes one or more electrical signals (e.g. voltages) to be supplied to the appropriate electrical connections within the color-changing light source 110 via the electrical cable 111, as shown in FIGS. 2A-2C. Aspects include the color-changing light source 110 thus receiving the appropriate electrical signals to cause the colors produced by the color-changing light source 110 to change based upon the position of the lighted guard assembly and/or an operational state of a machine associated with the lighted guard assembly, as further discussed below. In some aspects, the electrical signals may be voltages that are selectively turned on and off at specific wires or nodes within the cable 111, which are in turn connected to terminals, wires, nodes, etc. associated with the different colored LEDs or other suitable lights within the color-changing light source 110. In accordance with such aspects, “on” and “off” voltage levels may be provided to the individual colored LEDs within the color-changing light source 110 to facilitate the color-changing light source 110 producing different colored light by turning sets of individual colored LEDs either on or off.

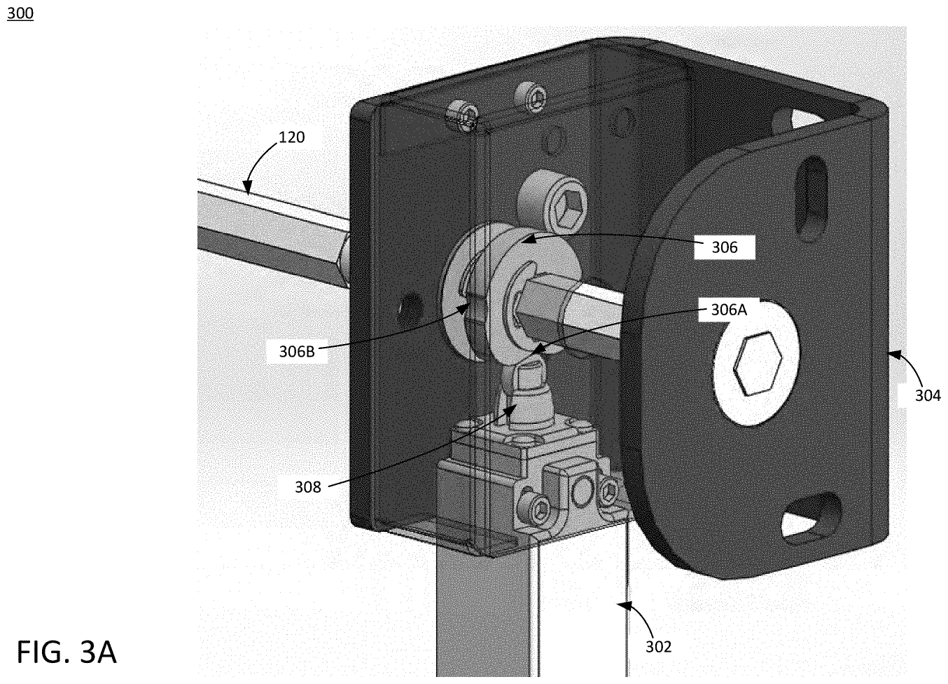

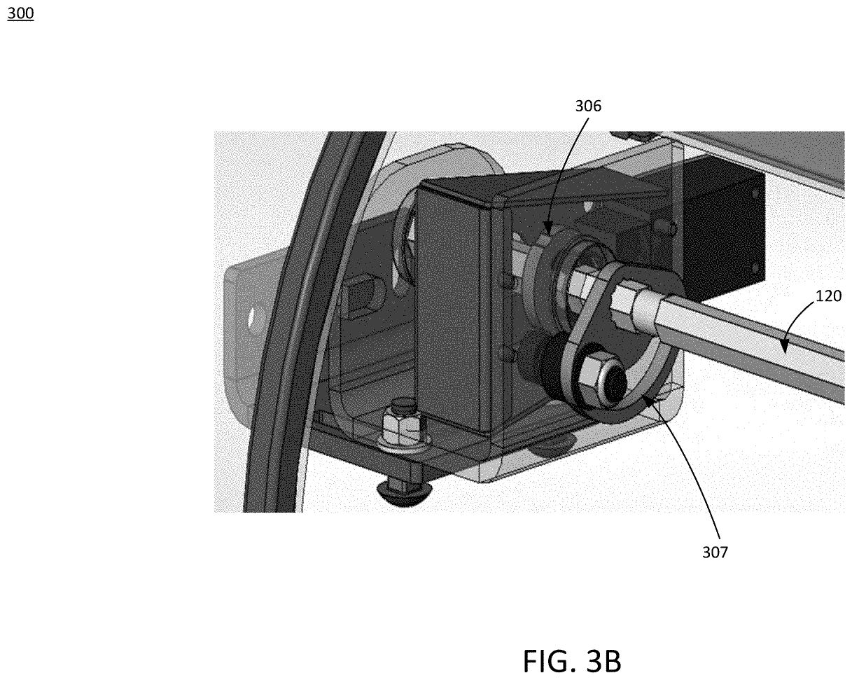

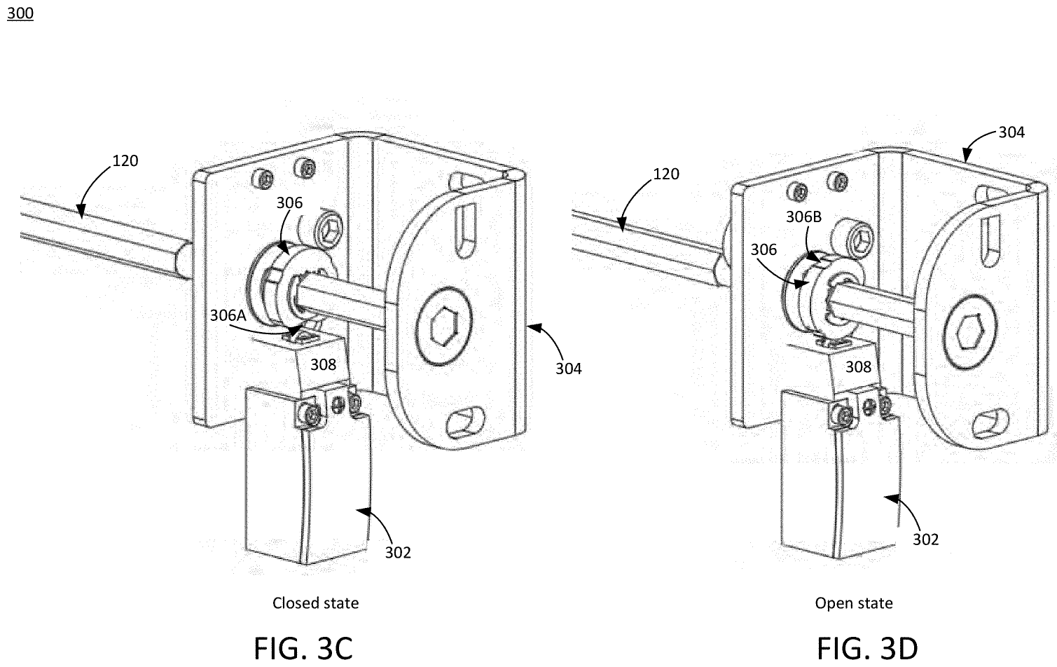

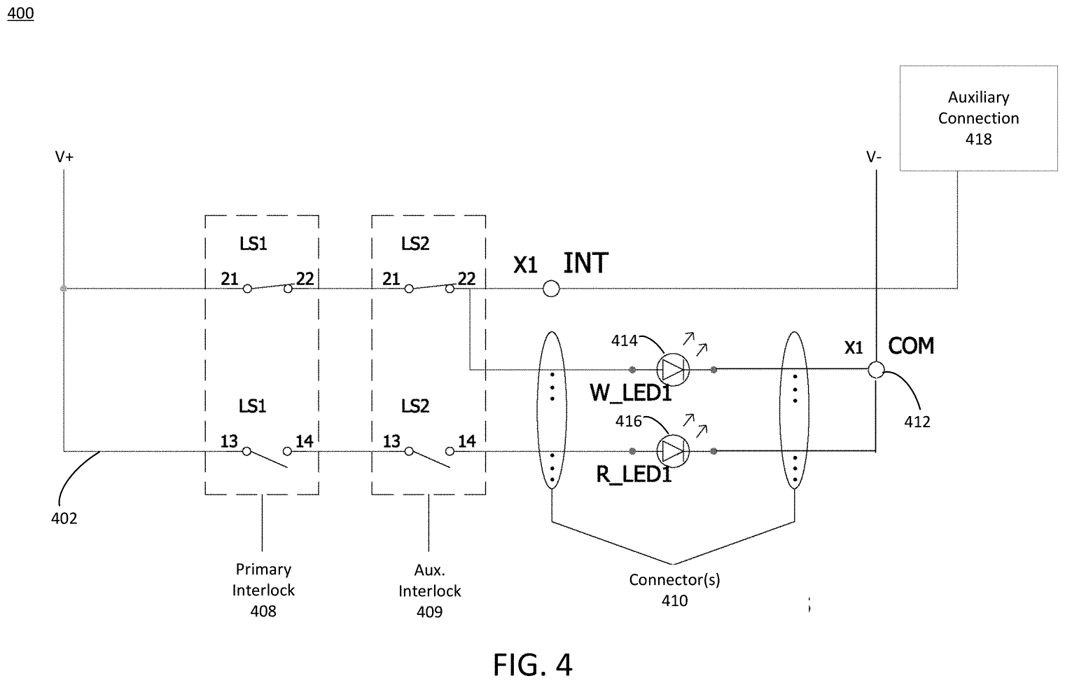

Additional details with respect to the electrical operation of the color-changing light source 110, which results in the emission of different colored lights in different scenarios, is further discussed below with respect to FIG. 4. In an aspect, the electrical signals provided to the color-changing light source 110 may be in response to the state of one or more interlock systems, which cause the color-changing light source 110 to selectively emit light in various different colors and/or to not emit light at all (e.g. be in the off state). In an aspect, one of these interlock systems may include a mechanical switch actuator system 300, which is shown in FIG. 3A-3D. The mechanical switch actuator system 300 may be used to indicate the position of the lighted guard assembly 140 by changing the state of one or more switches. As shown in FIG. 3A, the mechanical switch actuator system 300 includes a mounted bracket 304 through which the rotatable shaft 120 passes through. Again, the rotatable shaft 120 is coupled to the guard 102, as shown in FIGS. 1A-1F. Thus, the bracket 304 may remain stationary as the lighted guard assembly 140 is positioned from the closed and protective state as shown in FIGS. 1A-1B, to the open and unprotective state as shown in FIGS. 1C-1E, and back again. The rotatable shaft 120 may freely rotate within the bracket 304 via the use of bushings and/or other appropriate captivating fasteners.

The mechanical switch actuator system 300 as shown includes a cam 306, which is fixedly mounted to the rotatable shaft 120 such that, when the cam 306 changes position as the lighted guard assembly 140 is moved into different positions as noted above, the rotatable shaft 120 also rotates as a result. Furthermore, the lighted guard system 100 may include additional cams coupled to the rotatable shaft 120, such as the cam 307 as shown in FIG. 3B. This second cam may function, for instance, as a physical stop for the rotatable shaft 120, which may correspond to the position shown in FIG. 1E for example. Although the aspects as described herein are with respect to the cam 306, this is by way of example and any suitable number of switches may be coupled to or otherwise associated with additional cams, such as the cam 307 as shown in FIG. 3B for example, to detect positions in addition to or instead of those of the cam 306. In an aspect, the cam 306 is shaped as shown in FIGS. 3A-3D to cause a switch 308, which may be coupled to a spring-loaded or mechanically biased contact, for instance, to be in one of two different states or positions. In a first position as shown in FIGS. 3A and 3C, the contact of the switch 308 abuts with the concave portion 306A of the cam 306 (or fails to abut the cam 306 due to the depth of the concave portion 306A), causing the switch 308 to be extended and in a first state. The first state of the switch 308 may correspond, for example, to the closed and protective position of the lighted guard assembly 140 as shown in FIGS. 1A-1B. Thus, when the lighted guard assembly 140 is closed and in the protective position, the switch 308 is in a first switching state that causes the color-changing light source 110 to emit white light to flood onto the work area (e.g. as shown in FIG. 2B).

In a second state or position, which is shown in FIG. 3D, the contact of the switch 308 is compressed as the concave portion of the cam 306 is rotated beyond a contact point, during which the switch 308 abuts with one of the non-concave portions of the cam 306. In this second position, the switch 308 is in a second state, which may correspond to the open and unprotective position of the lighted guard assembly 140 as shown in FIGS. 1C-1E (or any other position of the lighted guard assembly 140 other than the closed and protective position shown in FIG. 1A). This may occur, for example, when the lighted guard assembly 140 is moved out of the operating position for maintenance or part-loading, causing the switch 308 to be placed into the second switching state and thus causing the color-changing light source 110 to emit red light to flood onto the work area (e.g. as shown in FIG. 2C).

Although the cam 306 and switch 308 are shown in FIGS. 3A, 3C, and 3D as providing two different switching states associated with the position of the lighted guard assembly 140, aspects include the cam 306 and the switch 308 being configured to generate any suitable number of switching states in addition to the first and second switching states discussed herein. For instance, the cam 306 may have multiple concave areas or detents of different cutback dimensions, causing the switch 308 to be in one of several different positions associated with contacting each different concave portion of the cam 306, and thereby facilitating the generation of electrical signals that indicate a different state of the lighted guard assembly 140 for several different rotational positions of the cam 306 with respect to the switch 308.

Moreover, irrespective of the number of switching states of the switch 308, aspects include the cam 306 including additional detents or concave portions (e.g. detect 306B) to provide additional mechanical support and assist in maintaining the lighted guard assembly 140 in the open position, when desired. For example, the detent 306B may correspond to the position of the lighted guard assembly 140 as shown in FIG. 1E, which is beyond the trigger point of the open position of the lighted guard assembly 140 as shown FIG. 1D to facilitate a larger region for loading and unloading material, for instance, into the work area. The detent 306B may be of dimensions such that the alignment of the contact of the switch 308 with the cam 306 is still sufficiently compressed to maintain the switch 308 in the second state, and thus the color-changing light source 110 to emit red light to flood onto the work area.

Although the aspects are described herein with the use of the cam and rotatable shaft 120 to cause the switch 308 to be in one of several different switching states, this is by way of example and not limitation. The aspects described herein may implement any suitable type of switch-based system to provide the appropriate voltage levels to the color-changing light source 110 to emit the desired colored light based upon any suitable position of the lighted guard assembly 140. This may include, for instance, other types of switches that may or may not work in conjunction with cams. As another example, the switch-based system that provides the appropriate voltage levels to the color-changing light source 110 may be implemented in accordance with a position sensor such as an infrared-based system, an image-based system (e.g. a camera), etc.

The electrical functionality of the lighted guard system 100 is further discussed below with reference to FIG. 4. As shown in FIG. 4, the lighted guard electrical system 400 includes a positive voltage supply V+ and a ground, common, or negative voltage supply V−. The positive and negative supply voltages may be supplied, for instance, via any suitable type of voltage source and/or regulator, which is not shown in FIG. 4 for purposes of brevity but may supply the V+ and V− voltages in accordance with any suitable voltage and/or current levels based upon the requirements of the color-changing light source 110, in various aspects. For example, the V+ voltage supply may be 24 volts, 12 volts, 5 volts, etc., whereas the V− voltage supply may be a ground voltage. In the example shown in FIG. 4, the color-changing light source 110 uses a set of white LEDs 414 and a set of red LEDs 416, but again this is by way of example and not limitation. The white and red LEDs 414, 416 may include any suitable number within a set of LEDs that are integrated as part of the color-changing light source 110, and may be wired in parallel with one another such that each white LED 414 and red LED 416 shares the same anode node and cathode node, respectively, with other similar-colored LEDs in the color-changing light source 110. The connector(s) 410 may function to couple the color-changing light source 110 to the other electrical components in the lighted guard system 100, such as via the electrical cable 111 as shown and discussed above, for instance.

The lighted guard electrical system 400 includes a primary interlock 408 that may be identified, for example, with the switch 308 as shown and described above with reference to FIGS. 3A-3D. Alternatively, the primary interlock 408 may be implemented as a separate switch that receives control signals (not shown) via the switch 308 to change the switching state of the switches included as part of the primary interlock 408 based upon one or more positions of the cam 306, for instance. The secondary or auxiliary interlock 409 is optional, and will be further discussed below. Therefore, the current explanation omits the functionality of the auxiliary interlock 409 for ease of explanation, assuming that the functionality of the circuit shown in FIG. 4 in the absence of the auxiliary interlock 409 would be the same as the switches associated with the auxiliary interlock 409 being both closed.

In the example shown in FIG. 4, the switch 308 is a single-pole multi-throw switch, but aspects include other suitable types and configurations of switches depending upon the number of switching states desired. Moreover, the switch 308 may be a solid-state relay or other suitable component configured to selectively couple voltages to the white LEDs 414 and red LEDs 416 to provide the same functionality as the witch 308 as discussed herein. Continuing the example as shown in FIG. 4, the switch 308 is in the first state (see FIGS. 3A and 3C) corresponding to the lighted guard assembly 140 being in the closed and protective position as shown in FIGs. 1A-1B. In this state, the switch connecting the contacts 21 and 22 of the switch 308 is closed, and the switch connecting the contacts 13 and 14 is open. Thus, the V+ voltage is supplied to the anode of the white LEDs 414, whereas the anode of the red LEDs 416 is decoupled from the V+ voltage supply. This causes the color-changing light source 110 to emit white light to flood onto the work area (e.g. as shown in FIG. 2B). However, the switch 308 in the second state as shown in FIG. 3D corresponds to the lighted guard assembly 140 being in the open and unprotective position as shown in FIGS. 1C-1E. In the second state, the switch connecting the contacts 21 and 22 of the switch 308 is open, and the switch connecting the contacts 13 and 14 is closed (not shown). Thus, the V+ voltage is supplied to the anode of the red LEDs 416, whereas the anode of the white LEDs 414 is decoupled from the V+ voltage supply. This causes the color-changing light source 110 to emit red light to flood onto the work area (e.g. as shown in FIG. 2C).

In an aspect, additional switches and/or interlock circuits may be implemented, and the color of the lights emitted by the color-changing light source 110 (or whether light is emitted at all) may be dependent upon any suitable number of such interlocks, instead of or in addition to those provided by the primary interlock 408 as shown in FIG. 4. For example, and as discussed above with reference to the primary interlock 408, the auxiliary interlock 409 may be implemented as and/or coupled to any other suitable switches (e.g. additional cam switches associated with the same or other components in which the lighted guard system 100 is implemented, with positional changes of such components (e.g., additional cams) causing changes in the switching state of the auxiliary interlock 409. Additionally or alternatively, the switching state of the auxiliary interlock 409 may be coupled to and/or controlled by one of more controllers or portions of a particular machine with which the lighted guard system 100 is associated.

The auxiliary interlock 409 may thus cause the machine to become non-operational via communication with a safety monitoring relay and/or safety control panel, for example, which may be identified with the auxiliary connection 418. Thus, when wired in series with the auxiliary interlock 409, the primary interlock 408 enables the machine associated with the lighted guard assembly to operate via communication with such safety monitoring relay and/or other suitable components such as one or more other suitable relays, force guided relays, safety control panel components, etc. when the lighted guard assembly 140 is in the closed position, as such components are configured to detect the V+ voltage under these conditions. In other words, the auxiliary interlock 409, when present, may receive signals from the primary interlock 409 and provide further switching of these signals based upon one or more other components and/or conditions (e.g. a position of the second cam 307, the operational state of a machine associated with the lighted guard system 100, the state or position of another component that may or may not be associated with the lighted guard system 100, etc.). When the auxiliary interlock 409 is present, both the primary interlock 408 and the auxiliary interlock 409 need to be in the closed position with respect to their respective switching states (e.g. the switch connecting the contacts 21 and 22 in each of the primary and auxiliary interlocks 408, 409) to cause the white LEDs 414 and the red LEDs 416, respectively, to emit light of their respective colors. Thus, the use of the auxiliary interlock 409 may optionally function as part of an interlock circuit to additionally ensure that a machine is only operational when the lighted guard assembly 140 is in the closed or protective position. Thus, in various aspects, the auxiliary interlock 409 may operate in conjunction with the position of the lighted guard assembly 140 or independently of the position of the lighted guard assembly 140.

Therefore, when the position of the lighted guard assembly 140 functions as part of an interlock circuit, the operational state of the machine associated with the lighted guard assembly 140 may be tied to the position of the lighted guard assembly 140, such that the operation of the machine associated with the lighted guard assembly is dependent upon the position of the lighted guard assembly 140. However, aspects include the machine associated with the lighted guard assembly 140 having any suitable number of interlocks, with a failure of any one of the interlocks preventing operation of the machine. One of these interlocks may optionally be driven by the position of the lighted guard assembly 140 as noted above, with any suitable number of additional or alternate interlocks being present that indicate whether the machine associated with the lighted guard assembly 140 is operational based upon the position of other guards, the position of safety switches, etc. In various aspects, the color and/or state (e.g. on or off) of light emitted via the color-changing light source 110 may be based upon any combination of these interlock states, in addition to or as an alternative to the position of the lighted guard assembly 140.

For example, although FIG. 4 depicts the primary interlock 408 and the auxiliary interlock switch 409 as being coupled in series with one another such that the respective switches of each need to be in the same position to drive the white and red LEDs 414, 416, this is by way of example and not limitation. As an additional example, the primary interlock 408 and the auxiliary interlock 409 may be wired in parallel with one another. In this configuration, the state of the primary interlock 408 and the auxiliary interlock 409 (which may be influenced by the state of the machine associated with the lighted guard assembly 140) may independently control whether the V+ voltage source is supplied to the white LEDs 414 and the red LEDs 416.

The circuit shown in FIG. 4 is by way of example and not limitation, and the aspects described herein may couple voltages to the white LEDs 414 and the red LEDs 416 in any suitable manner. For instance, electrical signals may be provided via any suitable manner in response to the change in the position of the lighted guard assembly 140. These electrical signals may cause the color-changing light source 110 to emit colors depending upon the position of the lighted guard assembly 140, the operational state of a machine associated with the lighted guard assembly 140, and/or based upon any other suitable conditions, which may be identified by any suitable application and/or translation of logic associated with each of the primary interlock circuit 408, the secondary interlock circuit 409, additional interlock circuits not shown for purposes of brevity, or any other suitable condition that may be identified with a defined logical or electrical state.

Furthermore, aspects include the color-changing light source 104 changing between emitting various different colored lights, which may be two different colored lights as shown in FIGS. 2A and 5A (e.g. white) and FIGS. 2B and 5B (e.g. red). The two different colors described herein are provided by way of example and not limitation, and the color-changing light source 110 may emit different colored lights for any suitable number of different positions of the lighted guard assembly 140, operating states of the machine associated with the lighted guard assembly 140, and/or other machines or conditions as relevant. Moreover, the color-changing light source 110 may adjust other parameters of its operation based upon these aforementioned conditions, such as the intensity of the emitted light (e.g. brightness), the light being turned on (at any color) or off (to emit no light), the light flashing at any suitable frequency and color, etc.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

What is claimed is:

1. A lighted guard assembly, comprising:
a safety guard;
a frame coupled to the safety guard; and
a color-changing light source configured to emit light having a first color when the lighted guard assembly is in a first position, and to emit light having a second color when the lighted guard assembly is in a second position.

2. The lighted guard assembly of claim 1, wherein the color-changing light source is a strip of light-emitting diodes (LEDs).

3. The lighted guard assembly of claim 2, wherein the strip of LEDs includes a first set of LEDs configured to emit light having the first color, and a second set of LEDs configured to emit light having the second color.

4. The lighted guard assembly of claim 3, wherein the first set of LEDs are configured to emit the first color of light as white, and
wherein the second set of LEDs are configured to emit the second color of light as red.

5. The lighted guard assembly of claim 1, wherein the color-changing light source is configured to emit the first color of light as white, and to emit the second color of light as red.

6. The lighted guard assembly of claim 1, wherein the color-changing light source is mounted to an inside edge of the frame.

7. The lighted guard assembly of claim 1, wherein the first position of the lighted guard assembly comprises the safety guard being in a closed or protective position with respect to a machine associated with the lighted guard assembly, and
wherein the second position of the lighted guard assembly comprises the safety guard being in an open or unprotective position with respect to the machine.

8. The lighted guard assembly of claim 1, wherein the color-changing light source is configured to emit light having either the first color or the second color based upon a state of a switch that is configured to have a state that corresponds to a position of the lighted guard assembly.

9. The lighted guard assembly of claim 8, wherein:
the switch is configured to have a first state when the lighted guard assembly is in the first position and to have a second state when the lighted guard assembly is in the second position, and
the first state of the switch causes a voltage to be coupled to a first set of light-emitting diodes (LEDs) included in the color-changing light source to cause the color-changing light source to emit light having the first color, and
the second state of the switch causes the voltage to be coupled to a second set of LEDs included in the color-changing light source to cause the color-changing light source to emit light having the second color.

10. The lighted guard assembly of claim 8, wherein the color-changing light source is configured to emit light having either the first color or the second color based upon a state of an interlock switch that is configured to have a switching state that is based upon an operational state of a machine that is associated with the lighted guard assembly.

11. A lighted guard system, comprising:
a lighted guard assembly;
a rotatable shaft coupled to the lighted guard assembly; and
a mechanical switch actuator system coupled to the rotatable shaft,
wherein the mechanical switch actuator system includes a switch configured to have a first state or a second state that corresponds to the lighted guard assembly being in a first position or a second position, respectively, and
wherein the lighted guard assembly includes a color-changing light source configured to emit light having a first color or a second color based upon the switch being in one of the first state or the second state.

12. The lighted guard system of claim 11, wherein the color-changing light source is a strip of light-emitting diodes (LEDs).

13. The lighted guard system of claim 12, wherein the strip of LEDs includes a first set of LEDs configured to emit light having the first color, and a second set of LEDs configured to emit light having the second color.

14. The lighted guard system of claim 13, wherein the first set of LEDs are configured to emit the first color of light as white, and
wherein the second set of LEDs are configured to emit the second color of light as red.

15. The lighted guard system of claim 11, wherein the color-changing light source is configured to emit the first color of light as white, and to emit the second color of light as red.

16. The lighted guard system of claim 1, wherein the color-changing light source is mounted to an inside edge of a frame of the lighted guard assembly.

17. The lighted guard system of claim 1, wherein the lighted guard assembly includes a safety guard, and
wherein the first position of the lighted guard assembly comprises the safety guard being in a closed or protective position with respect to a machine associated with the lighted guard assembly, and
wherein the second position of the lighted guard assembly comprises the safety guard being in an open or unprotective position with respect to the machine.

18. The lighted guard system of claim 1, wherein the mechanical switch actuator system comprises a cam coupled to the rotatable shaft, the cam rotating as a result of the lighted guard assembly being moved between the first position and the second position, and
wherein the switch includes a contact that abuts the cam when the lighted guard assembly is in at least one of the first position or the second position, thereby causing the switch to be in the first state or the second state, respectively.

19. The lighted guard system of claim 18, wherein:
the first state of the switch causes a voltage to be coupled to a first set of light-emitting diodes (LEDs) included in the color-changing light source to cause the color-changing light source to emit light having the first color, and
the second state of the switch causes a voltage to be coupled to a second set of LEDs included in the color-changing light source to cause the color-changing light source to emit light having the second color.

20. The lighted guard system of claim 11, wherein the color-changing light source is configured to emit light having either the first color or the second color based upon a state of an interlock switch that is configured to have a switching state that is based upon an operational state of a machine that is associated with the lighted guard system.
